(19) United States
(12) Patent Application Publication
(10) Pub. No.: US 2022/0322094 A1
(43) Pub. Date: Oct. 6, 2022

(54) MESSAGE VERIFICATION OPTIMIZATION

(71) Applicant: QUALCOMM Incorporated, San Diego, CA (US)

(72) Inventors: Sean Vincent MASCHUE, Encinitas, CA (US); Johnathan COBDEN-NOLAN, San Diego, CA (US); Mohammed Ataur Rahman SHUMAN, San Diego, CA (US); Soumya DAS, San Diego, CA (US); Sivaramakrishna VEEREPALLI, San Diego, CA (US)

(21) Appl. No.: 17/657,106

(22) Filed: Mar. 29, 2022

Related U.S. Application Data
(60) Provisional application No. 63/168,163, filed on Mar. 30, 2021.

(51) Int. Cl. H04W 12/106; H04W 12/04; H04W 12/00; H04W 4/40

(52) U.S. Cl. CPC H04W 12/106; H04W 12/04; H04W 12/009; H04W 4/40

(57) ABSTRACT

Apparatus, methods, and computer program products for cache building for cryptographic verification that may be used in connection with a V2X communication system are provided. An example method includes receiving, from a second wireless device, at least one V2X message of a plurality of V2X messages, the at least one V2X message being associated with a verification key. The example method further includes determining whether the verification key for the at least one V2X message is a target verification key. The example method further includes determining, if the verification key is the target verification key, to generate an entry in a cache for the verification key. The example method further includes generating, upon determining to generate the entry in the cache, the entry in the cache for the verification key.

### CROSS REFERENCE TO RELATED APPLICATION(S)

This application claims the benefit of and priority to U.S. Provisional Application Ser. No. 63/168,163, entitled “MESSAGE VERIFICATION OPTIMIZATION” and filed on Mar. 30, 2021, which is expressly incorporated by reference herein in its entirety.

### TECHNICAL FIELD

The present disclosure relates generally to cache building for cryptographic verification, and more particularly, to cryptographic verification that may be used in connection with vehicle-to-everything (V2X) wireless communication systems.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, an apparatus, and a computer-readable medium at a wireless device are provided. The wireless device may receive, from a second wireless device, at least one vehicle-to-everything (V2X) message of a plurality of V2X messages, the at least one V2X message being associated with a verification key. The wireless device may determine whether the verification key for the at least one V2X message is a target verification key. The wireless device may determine, if the verification key is the target verification key, to generate an entry in a cache for the verification key. The wireless device may generate, upon determining to generate the entry in the cache, the entry in the cache for the verification key.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2 illustrates example aspects of a sidelink slot structure.

FIG. 3 is a diagram illustrating an example of a first device and a second device involved in wireless communication based, e.g., on V2X and/or other device-to-device communication.

FIG. 4 illustrates example wireless communication between devices based on V2X.

FIG. 5 illustrates example cache building.

FIG. 6 illustrates example V2X communication in connection with cache building.

FIGS. 7A-7C illustrate example cache building and cache entry size related to a V2X communication area.

FIG. 8 is a flowchart of a method of cache building for cryptographic verification related to communication.

FIG. 9 is a flowchart of a method of cache building for cryptographic verification related to communication.

FIG. 10 is a diagram illustrating an example of a hardware implementation for an example apparatus.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

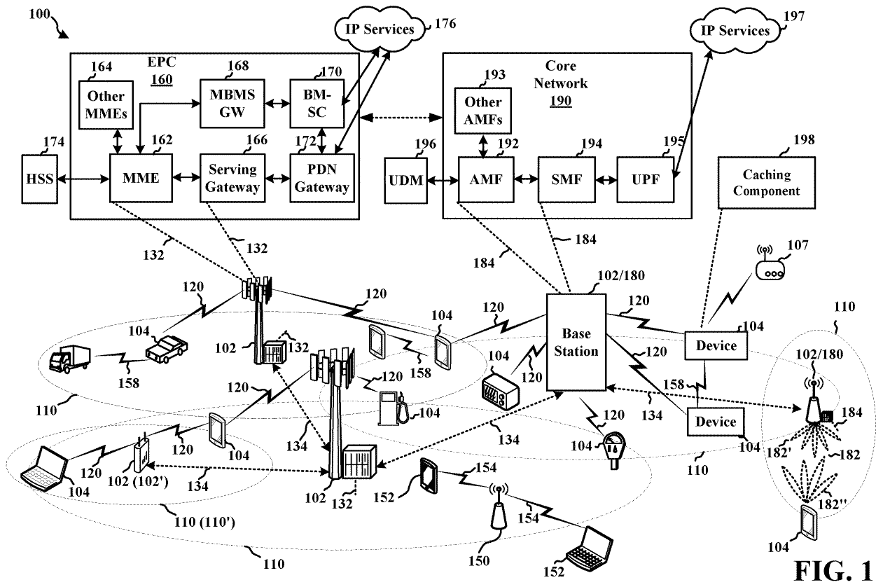

FIG. 1 is a diagram illustrating an example of a wireless communications system and an access network 100. The wireless communications system (also referred to as a wireless wide area network (WWAN)) includes base stations 102, wireless devices 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

A link between a wireless device 104 and abase station 102 or 180 may be established as an access link, e.g., using a Uu interface. Other communication may be exchanged between wireless devices based on sidelink. For example, some wireless devices 104 may communicate with each other directly using a device-to-device (D2D) communication link 158. In some examples, the D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

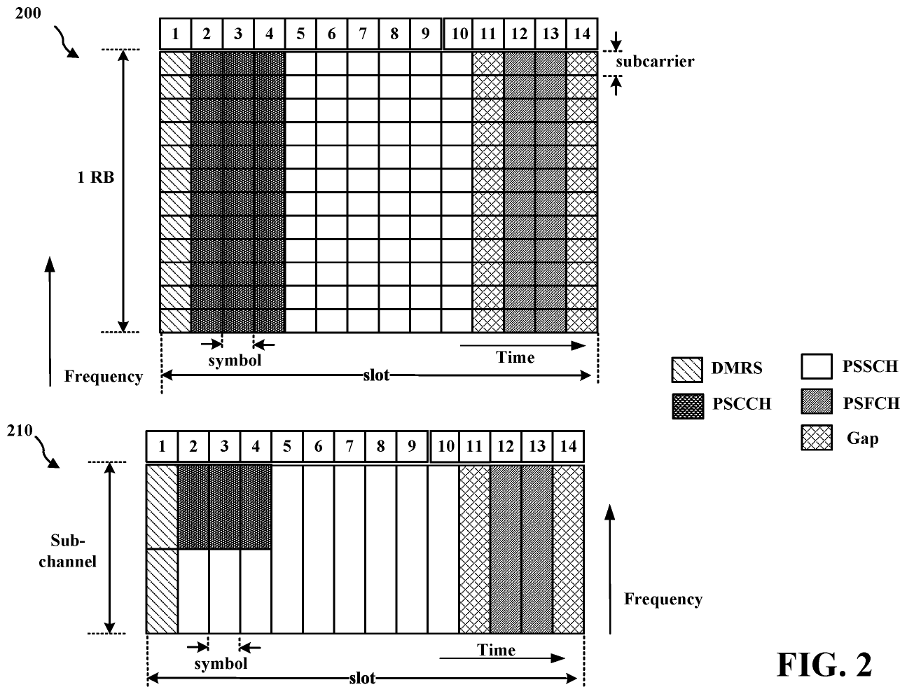

Some wireless communication networks may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as abase station), vehicle-to-pedestrian (V2P), cellular vehicle-to-everything (C-V2X), and/or a combination thereof and/or with other devices, which can be collectively referred to as vehicle-to-anything (V2X) communications. Referring again to FIG. 1, in certain aspects, a wireless device 104, e.g., an on board unit (OBU) deployed at a car, a Road Side Unit (RSU), a device with a vulnerable road user (VRU), or other wireless device, may be configured to transmit messages directly to another wireless device 104. The communication may be based on V2X or other D2D communication, such as Proximity Services (ProSe), etc. Communication based on V2X and/or other D2D communication may also be transmitted and received by other transmitting and receiving devices, such as RSU 107, etc. Aspects of the communication may be based on PC5 or sidelink communication e.g., as described in connection with the example in FIG. 2. Although the following description may provide examples for sidelink communication in connection with 5G NR, the concepts described herein may be applicable to other similar areas, such as LTE, LTE-A, CDMA, GSM, and other wireless technologies.

V2X communication such as C-V2X communication may enable vehicles to communicate with each other and everything around them. For example, C-V2X communication may enable vehicles to broadcast safety messages such as a basic safety message (BSM), intersection mapping (MAP), cooperative aware message (CAM), to other C-V2X enabled vehicles. Additional examples of safety messages may include signal phase and timing (SPaT), traveler information message (TIM), road safety management (RSM), signal request message (SRM), signal status message (SSM), or probe vehicle data (PVD). Some wireless technologies, such as 5G NR, may enable capabilities that enable advanced safety use cases to complement the basic safety messages such as a sensor data sharing message (SDSM), a maneuver sharing and coordinating message (MSCM), and a cooperative adaptive cruise control (CACC). These messages may also be called intelligent transport system (ITS) messages. Because vehicles may use these messages for safety applications and autonomous driving, reducing end-to-end latency may be important for the C-V2X message. At the same time, the receiver vehicle may make sure messages are coming from the authentic source. The receiver vehicle may receive such messages from OBUs on other vehicles, an RSU such as a traffic light, a wireless device with a vulnerable road user (VRU) such as a pedestrian or a cyclist, or the like. Maneuvering a vehicle based on a message from a non-authentic source that may be malicious may cause catastrophic failure. Therefore, the vehicles may be embedded with a dedicated hardware security module (HSM). In a dedicated HSM, each transmitted V2X application layer messages may be signed with a unique pseudonym certificate. A receiver may verify the certificate before using the message for safety applications or autonomous driving decision. However, such verification may introduce latency. Beyond just the latency that verification may add, as a vehicle may need to receive from hundreds (if not thousands) of nearby OBUs on vehicles, devices on pedestrians, and infrastructure RSUs, with messages from each source that may approach 50 Hz, the cryptographic workload on the verification of all these messages may be huge. For example, if there are 300 vehicles within a C-V2X range (e.g., 1 kilometer (km)). The receiver may receive 3000 messages per second for just BSM. Messages for advance applications such as SDSM, CPM, or the like, may be transmitted at a 10 Hz rate and may cause a higher verification load. Signed messages such as SPAT and TIM coming from the RSU may also add to the verification load for the receiver vehicle. Each wireless device may be using a unique key for each application data plane for at least some number of minutes before re-randomizing to a new pseudonym.

The ability to safely and efficiently process all the ITS messages may consume a variable amount of general purpose compute resources or dedicated hardware. The compute power cost may scale up with the reduced latency and efficiency of these verifications and may consume a prohibitively high amount of power for an OBU at a vehicle. Optimization for processing more verifications more quickly and efficiently may enable OBUs to verify the received messages without overloading processing power.

Because a vehicle may use the same certificate for a finite duration to sign all of its BSM/CAM or other messages, it may be possible to cache information related to a specific certificate which may reduce the verification latency significantly. The cache may include cryptographic cipher-specific pre-computed mathematical operations that may accelerate future verifications based on the same key. However, such caching itself may consume computing resources such as processing power and memory. In addition, caching for a new key may introduce additional latency to the verification. Aspects provided herein provide optimization for caching for a new key.

Referring again to FIG. 1, the wireless device 104 may be associated with an OBU, RSU, or a VRU, may include a caching component 198 configured to receive, from a second wireless device, at least one V2X message of a plurality of V2X messages, the at least one V2X message being associated with a verification key. The caching component 198 may be further configured to determine whether the verification key for the at least one V2X message is a target verification key. The caching component 198 may be further configured to determine, if the verification key is the target verification key, to generate an entry in a cache for the verification key. The caching component 198 may be further configured to generate, upon determining to generate the entry in the cache, the entry in the cache for the verification key.

The wireless communications system (also referred to as a wireless wide area network (WWAN)) includes base stations 102, wireless devices 104, an Evolved Packet Core (EPC) 160, and a Core Network (e.g., 5GC) 190. The base stations 102 may include macro cells (high power cellular base station) and/or small cells (low power cellular base station). The macro cells may include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for NR (collectively referred to as Next Generation RAN (NG-RAN)) may interface with Core Network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or Core Network 190) with each other over backhaul links 134 (e.g., X2 interface). The backhaul links 134 may be wired or wireless.

The base stations 102 may wirelessly communicate with the wireless devices 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the wireless devices 104 may include uplink (UL) (also referred to as reverse link) transmissions from a wireless device 104 to a base station 102 and/or downlink (DL) (also referred to as forward link) transmissions from a base station 102 to a wireless device 104. The communication links 120 may use multiple-input and multiple-output (MIMO) antenna technology, including spatial multiplexing, beamforming, and/or transmit diversity. The communication links may be through one or more carriers. The base stations 102/wireless devices 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain wireless devices 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the wireless device 104. When the gNB 180 operates in millimeter wave or near millimeter wave frequencies, the gNB 180 may be referred to as a millimeter wave base station. The millimeter wave base station 180 may utilize beamforming 182 with the wireless device 104 to compensate for the path loss and short range. The base station 180 and the wireless device 104 may each include a plurality of antennas, such as antenna elements, antenna panels, and/or antenna arrays to facilitate the beamforming.

Devices may use beamforming to transmit and receive communication. For example, FIG. 1 illustrates that a base station 180 may transmit a beamformed signal to the wireless device 104 in one or more transmit directions 182′. The wireless device 104 may receive the beamformed signal from the base station 180 in one or more receive directions 182″. The wireless device 104 may also transmit a beamformed signal to the base station 180 in one or more transmit directions. The base station 180 may receive the beamformed signal from the wireless device 104 in one or more receive directions. The base station 180/wireless device 104 may perform beam training to determine the best receive and transmit directions for each of the base station 180/wireless device 104. The transmit and receive directions for the base station 180 may or may not be the same. The transmit and receive directions for the wireless device 104 may or may not be the same. Although beamformed signals are illustrated between wireless device 104 and base station 102/180, aspects of beamforming may similarly may be applied by wireless device 104 or RSU 107 to communicate with another wireless device 104 or RSU 107, such as based on V2X, V2V, or D2D communication.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the wireless devices 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides wireless device IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The Core Network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the wireless devices 104 and the Core Network 190. Generally, the AMF 192 provides QoS flow and session management. All user Internet protocol (IP) packets are transferred through the UPF 195. The UPF 195 provides wireless device IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or Core Network 190 for a wireless device 104. Examples of wireless devices 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the wireless devices 104 may be referred to as IoT devices (e.g., parking meter, gas pump, toaster, vehicles, heart monitor, etc.). The wireless device 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

FIG. 2 includes diagrams 200 and 210 illustrating example aspects of slot structures that may be used for sidelink communication (e.g., between wireless devices 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 2 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 200 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may include 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 210 in FIG. 2 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2, some of the REs may include control information in PSCCH and some Res may include demodulation RS (DMRS). At least one symbol may be used for feedback. FIG. 2 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may include the data message described herein. The position of any of the data, DMRS, SCI, feedback, gap symbols, and/or LBT symbols may be different than the example illustrated in FIG. 2. Multiple slots may be aggregated together in some examples.

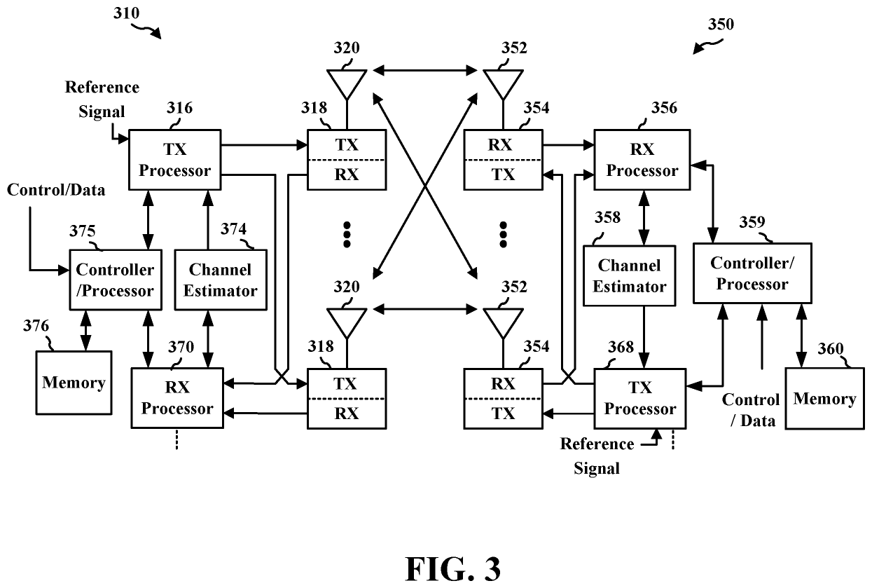

FIG. 3 is a block diagram of a first wireless communication device 310 in communication with a second wireless communication device 350. In some examples, the devices 310 and 350 may communicate based on V2X or other D2D communication. The communication may be based, e.g., on sidelink using a PC5 interface. The devices 310 and the 350 may include a wireless device, an RSU, a base station, etc. Packets may be provided to a controller/processor 375 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the device 350. Each spatial stream may then be provided to a different antenna 320 via a separate transmitter 318TX. Each transmitter 318TX may modulate an RF carrier with a respective spatial stream for transmission.

At the device 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the device 350. If multiple spatial streams are destined for the device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by device 310. These soft decisions may be based on channel estimates computed by the channel estimator 358. The soft decisions are then decoded and deinterleaved to recover the data and control signals that were originally transmitted by device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. The controller/processor 359 may provide demultiplexing between transport and logical channels, packet reassembly, deciphering, header decompression, and control signal processing. The controller/processor 359 is also responsible for error detection using an ACK and/or NACK protocol to support HARQ operations.

Similar to the functionality described in connection with the transmission by device 310, the controller/processor 359 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by device 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The transmission is processed at the device 310 in a manner similar to that described in connection with the receiver function at the device 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. The controller/processor 375 provides demultiplexing between transport and logical channels, packet reassembly, deciphering, header decompression, control signal processing. The controller/processor 375 is also responsible for error detection using an ACK and/or NACK protocol to support HARQ operations.

At least one of the TX processor 368, the RX processor 356, and the controller/processor 359 may be configured to perform aspects in connection with the caching component 198 of FIG. 1.

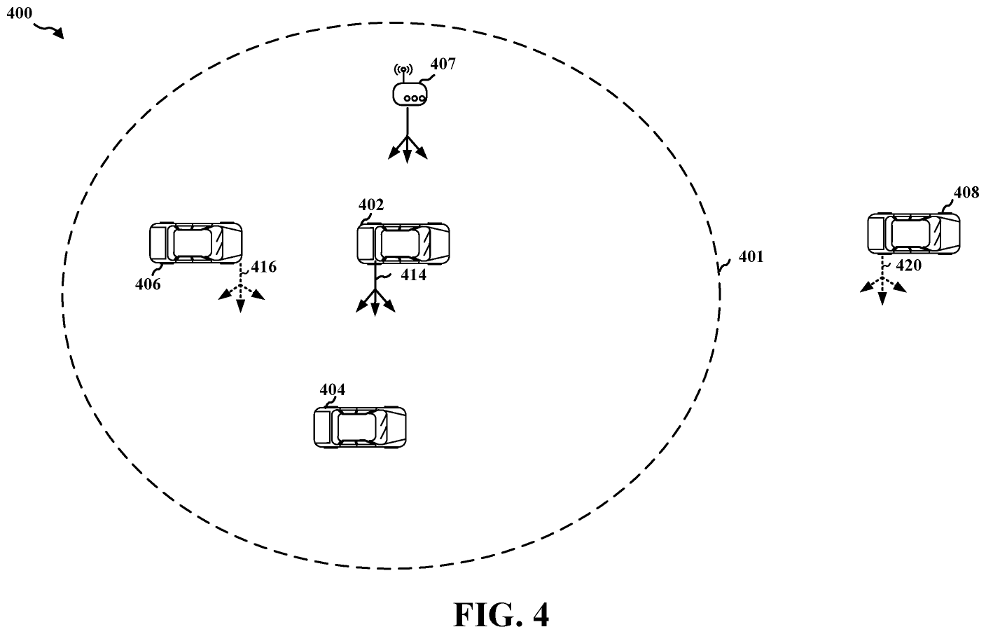

FIG. 4 illustrates an example 400 of wireless communication between devices based on V2X/V2V/D2D communication. The communication may be based on a slot structure including aspects described in connection with FIG. 2. For example, OBU 402 (which may also be a UE) may transmit a transmission 414, e.g., including a control channel and/or a corresponding data channel, that may be received by OBUs 404, 406, 408 (which may also be UEs). A control channel may include information for decoding a data channel and may also be used by a receiving device to avoid interference by refraining from transmitting on the occupied resources during a data transmission. The number of TTIs, as well as the RBs that will be occupied by the data transmission, may be indicated in a control message from the transmitting device. The OBUs 402, 404, 406, 408 may each be capable of operating as a transmitting device in addition to operating as a receiving device. Thus, OBUs 406, 408 are illustrated as transmitting transmissions 416, 420. The transmissions 414, 416, 420 may be broadcast or multicast to nearby devices. For example, OBU 414 may transmit communication intended for receipt by other OBUs within a range 401 of OBU 414. Additionally, RSU 407 may receive communication from and/or transmit communication to OBUs 402, 404, 406, 408. OBUs 402, 404, 406, 408 or RSU 407 may include the caching component 198 of FIG. 1. In some aspects, OBUs, RSUs, and VRUs may be able to communication with or without active connection to a base station. For example, V2X communications may be based on different types or modes of resource allocation mechanisms. In a first resource allocation mode (which may be referred to herein as “Mode 1”), centralized resource allocation may be provided by a network entity. For example, a base station 102 or 180 may determine resources for sidelink communication and may allocate resources to different OBUs, RSUs, and VRUs to use for V2X communications. In this first mode, a device may receive the allocation of resources from the base station 102 or 180. In a second resource allocation mode (which may be referred to herein as “Mode 2”), distributed resource allocation may be provided. In Mode 2, each device may autonomously determine resources to use. In order to coordinate the selection of sidelink resources by individual devices, each device may use a sensing technique to monitor for resource reservations by other devices and may select resources for sidelink transmissions from unreserved resources. The OBUs, RSUs, and VRUs may determine one or more radio resources in the time and frequency domain that are used by other devices in order to select transmission resources that avoid collisions with other devices. Thus, in the second mode (e.g., Mode 2), individual wireless devices may autonomously select resources for sidelink transmission, e.g., without a central entity such as a base station indicating the resources for the device.

V2X communication such as C-V2X communication may enable vehicles to communicate with each other and everything around them. For example, C-V2X communication may enable vehicles to broadcast safety messages such as a BSM, MAP, CAM, to other C-V2X enabled vehicles. Additional examples of safety messages may include SPaT, TIM, RSM, SRM, SSM, or PVD. Some wireless technologies, such as 5G NR, may enable capabilities that enable advanced safety use cases to complement the basic safety messages such as a SDSM, a MSCM, and a CACC. These messages may also be called ITS messages. Because vehicles may use these messages for safety applications and autonomous driving, reducing end-to-end latency may be important for the C-V2X message. At the same time, the receiver vehicle may make sure messages are coming from the authentic source. The receiver vehicle may receive such messages from OBUs on other vehicles, an RSU such as a traffic light, a wireless device with a VRU such as a pedestrian or a cyclist, or the like. Maneuvering a vehicle based on a message from a non-authentic source that may be malicious may cause catastrophic failure. Therefore, the vehicles may be embedded with a dedicated HSM. In a dedicated HSM, each transmitted V2X application layer messages may be signed with a unique pseudonym certificate. A receiver may verify the certificate before using the message for safety application or autonomous driving decision. However, such verification may introduce latency. Beyond just the latency that verification may add, as a vehicle may need to receive from hundreds (if not thousands) of nearby OBUs on vehicles, devices on pedestrians, and infrastructure RSUs, with messages from each source that may approach 50 Hz, the cryptographic workload on the verification of all these messages may be huge. For example, if there are 300 vehicles within a C-V2X range (e.g., 1 km). The receiver may receive 3000 messages/sec for just BSM. Messages for advance applications such as SDSM, CPM, or the like, may be transmitted at a 10 Hz rate and may cause a higher verification load. Signed messages such as SPAT and TIM coming from the RSU may also add to the verification load for the receiver vehicle. Each wireless device may be using a unique key for each application data plane for at least some number of minutes before re-randomizing to a new pseudonym.

The ability to safely and efficiently process all the ITS messages may consume a variable amount of general purpose compute resources or dedicated hardware. The compute power cost may scale up with the reduced latency and efficiency of these verifications and may consume a prohibitively high amount of power for an OBU at a vehicle. Optimization for processing more verifications more quickly and efficiently may enable OBUs to verify the received messages without overloading processing power.

Because a vehicle may use the same certificate for a finite duration to sign all of its BSM/CAM or other messages, it may be possible to cache information related to a specific certificate which may reduce the verification latency significantly. The cache may include cryptographic cipher-specific pre-computed mathematical operations that may accelerate future verifications based on the same key. However, such caching itself may consume computing resources such as processing power and memory. In addition, caching for a new key may introduce additional latency to the verification. Aspects provided herein provide optimization for caching for a new key. In some aspects, the cache may be a lookup table (LUT).

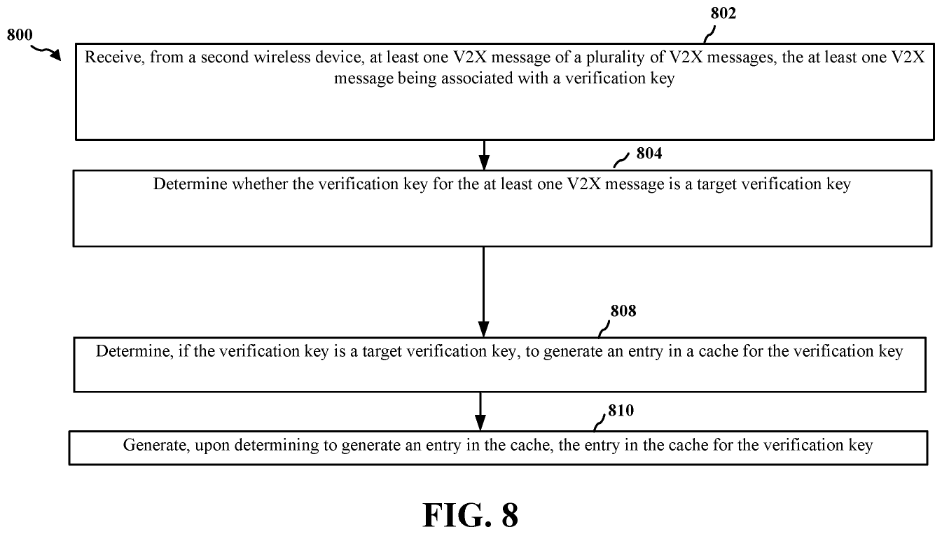

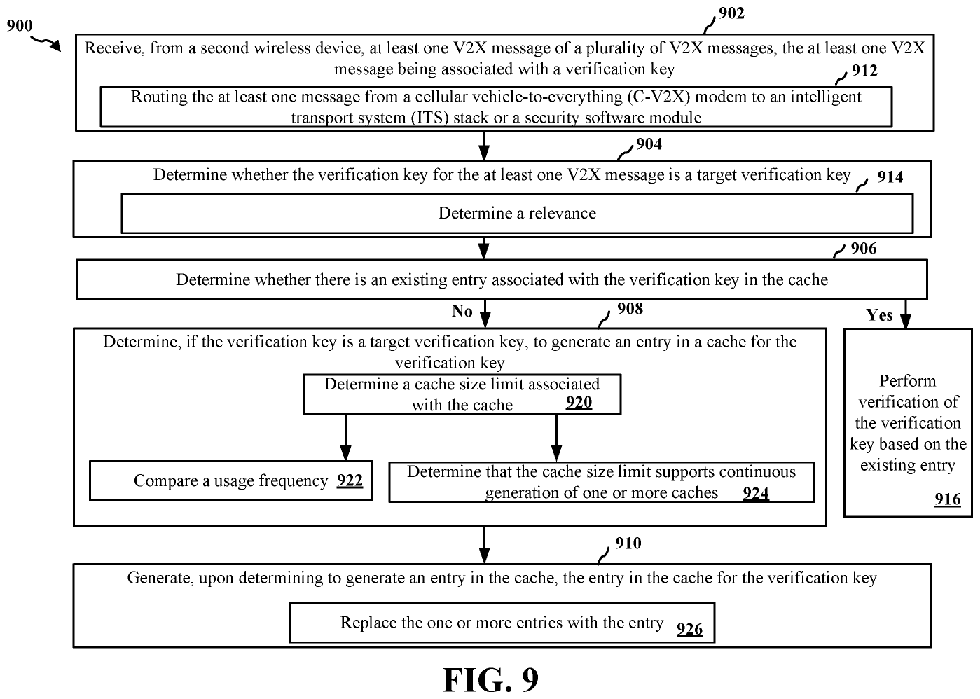

In some aspects, wireless devices, such as the OBUs 402, 404, 406, 408, or the RSU 407 may route a received message at the C-V2X modem to the ITS stack (as further described in connection with FIGS. 8 and 9). In some aspects, the ITS stack may include a security software component to verify the consistency and integrity via PKI/certificates per international standards, e.g., IEEE 1609.2. In some aspects, the wireless devices, such as the OBUs 402, 404, 406, 408, or the RSU 407 may use a cryptographic verification library to implement the asymmetric cipher verification of the secure protocol data unit (SPDU) of the message, such as by implanting elliptic curve cryptography (ECC) ciphers, e.g., National Institute of Standards and Technology (NIST)-P256, China SM-2, Brainpool-256, or the like. In some aspects, the wireless devices, such as the OBUs 402, 404, 406, 408, or the RSU 407 may use IEEE 802.11bd for dedicated short range communications (DSRC) and V2X to encrypt the message.

Cache building may add additional latency to the verification for a new key and may interfere with the verification process and other important tasks. If an ITS station (such as an OBU) powers-up in a crowded urban area, there may be thousands of new public keys to start processing. Cache building for the burst new certificates (and the associated public keys) of a V2X message may dominate CPU load and interrupt other latency sensitive tasks. In some aspects, a wireless device, such as a cache assistant of the wireless device as further described in FIGS. 8 and 9, may build cache entries at a periodic rate following the rate specified by a cache building period. In some aspects, the cache building period may be configurable. For example, the cache building period may be configurable may be configurable by the wireless device itself or by a network entity. In some aspects, the cache building period may be dynamic and based on the current and predictive load of the system. The wireless device may build cache entries in the background (not as a part of a verification request) as a lower priority thread in order to not add latency to a verification request. To handle burst arrival of the V2X message, the wireless device may decrease the cache building period.

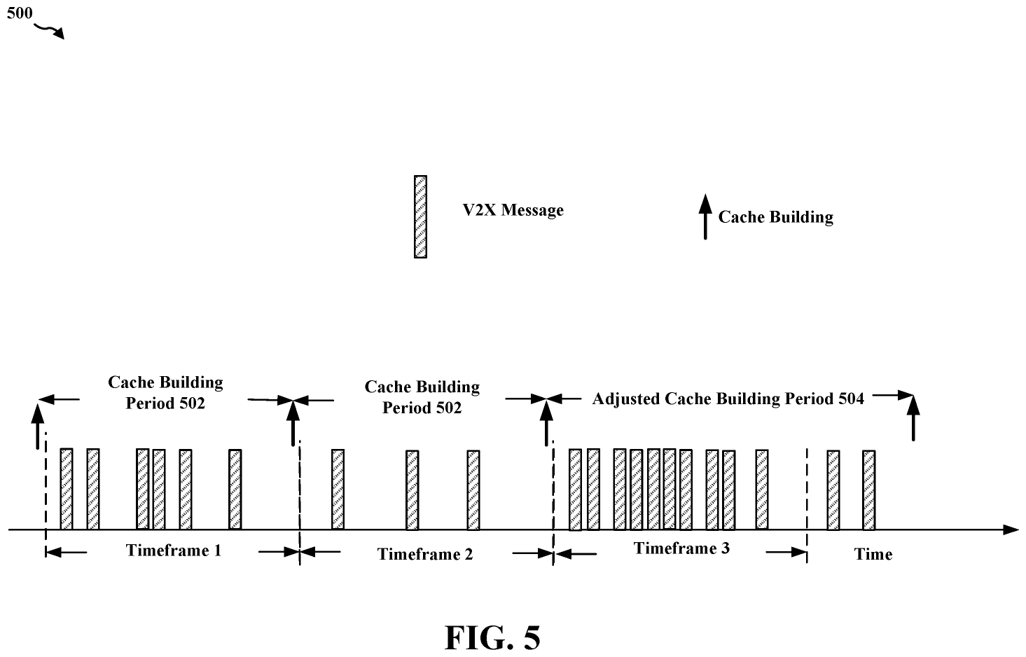

As illustrated in example 500 of FIG. 5, a wireless device may receive a number of V2X messages within a first time frame (time frame 1) and receive a number of V2X messages within a second time frame (time frame 2). The wireless device may build the cache according to the cache building period 502. If there is a burst arrival of the V2X messages in time frame 3, the wireless device may adjust the cache building period to the adjusted cache building period 504, decreasing the cache build rate and increasing the cache building period. For example, the wireless device may increase the cache building period in order to free up more processing power for verifying the messages.

In a congested environment, the number of keys may be more than the allocated cache size and it may not be possible to build a cache for all the keys. In some aspects, when the configured cache size is sufficient to support all keys being continuously verified (keys that are used at least once per X seconds), the cache assistant may build cache entries for all keys following the cache building period. When the number of cache entries allocated is fewer than a number of keys in periodic use (used at least once every X seconds), the cache assistant may replace cached entries with un-cached entries that are used more frequently for at least a Y Hz difference threshold. By replacing the least frequently used entries, the benefits of using the cache may be focused on the most frequently used keys.

In some aspects, a wireless device may build a cache based on a relevancy of the message. For example, some RSUs, OBUs, or other wireless devices may be in the range of the wireless device momentarily and some may be within the range for a longer duration. In addition to making a choice based on the relative frequency of use of any given key, additional application plane meta data, in the contents of the CPM, BSM, CAM, or geonetworking headers, may be used to further optimize the decision about which cache tables are likely to be worth the investment based on cost to build. For example, the cache assistant may select the keys for OBUs, RSUs, or devices of VRUs which are most likely to be in range for the longest amount of predict future time (based on location, heading, station location/speed/heading of the device that transmitted the message). For example, if the transmitting device is heading away from the receiving device at high speed and the distance is growing, it may be likely that the key is less relevant and may not be a candidate for which to build a cache entry.

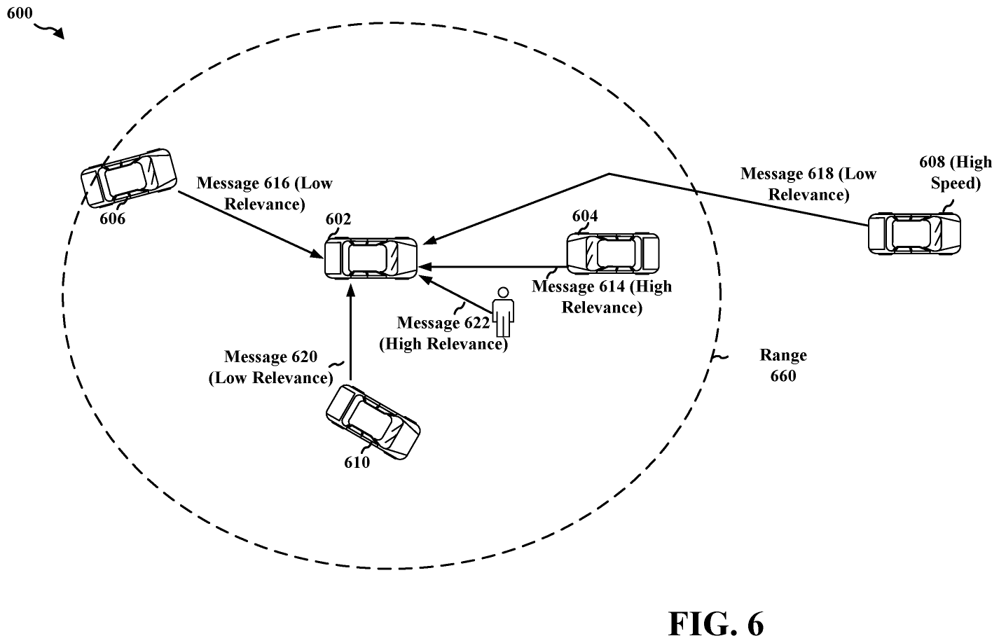

For instance, as illustrated in example 600 of FIG. 6, for the OBU 602, if the OBU 608 of a further distance is moving away from 602 at a high speed, the message 618 from the OBU 608 may be less relevant and the OBU 602 may not build a cache entry for the message 618. As further illustrated in example 600, for the OBU 602, if the OBU 604 is close to the OBU 602 and is heading towards the OBU 602, the message 614 from the OBU 604 may be of high relevancy and the OBU 602 may build a cache entry for the message 614. Similarly, for the OBU 602, if the OBU 606 and the OBU 610 is not heading towards the OBU 602, the message 616 from the OBU 604 and the message 620 from the OBU 610 may be of low relevancy and the OBU 602 may not build a cache entry for the message 616 and the message 620. In some aspects, a message 622 from a device from a nearby VRU that is moving towards the OBU 602 may be of high relevancy and the OBU 602 may build a cache entry for the message 622. In some aspects, the OBU 602 may use a range 660 for determining whether to build an entry for a key. For example, if the device transmitting the message associated with the key is outside the range 660, the OBU 602 may determine to not build an entry for the key.

In some aspects, the OBU 602 may additionally use a local dynamic map which may include a location of OBUs or RSUs and a history of previous duration of exposure for the OBUs or RSUs. For example, the previous duration of exposure may be a length of typical stop-lights and may be a vehicle stopped near the OBU 602. In some aspects, the OBU 602 may use the relevancy such as a direction/heading, a speed, or a distance (which may indicate a time to collision) of the transmitting device to determine which public keys to consider for pre-computation for generating a cache entry. Target classification (TC) may be done and the results may be fed into a cache assistant for the priority determination and determining which keys are to be handled first or which keys need to be removed from the cache. For example, RSUs, OBUs, and VRUs may be classified. In another example, other classifications may be further introduced. In some aspects, certificate expiry may also be considered in determining the priority. For example, the OBU 602 may not generate a cache entry for a certificate that is expiring soon because the certificate that is expiring soon may be less likely to be received again.

In some aspects, a size of entry for the cache may be based on an environment surrounding the OBU. An OBU may learn the environment (date, time, place) and may use analytics/other sensor(s) and use appropriate algorithm(s) to select the correct entry size. For example, in a congested environment with slow speed traffic, a cache with more entries with less information for each entry may be used. For a less congested environment, a cache with more entries with less information for each entry may be used.

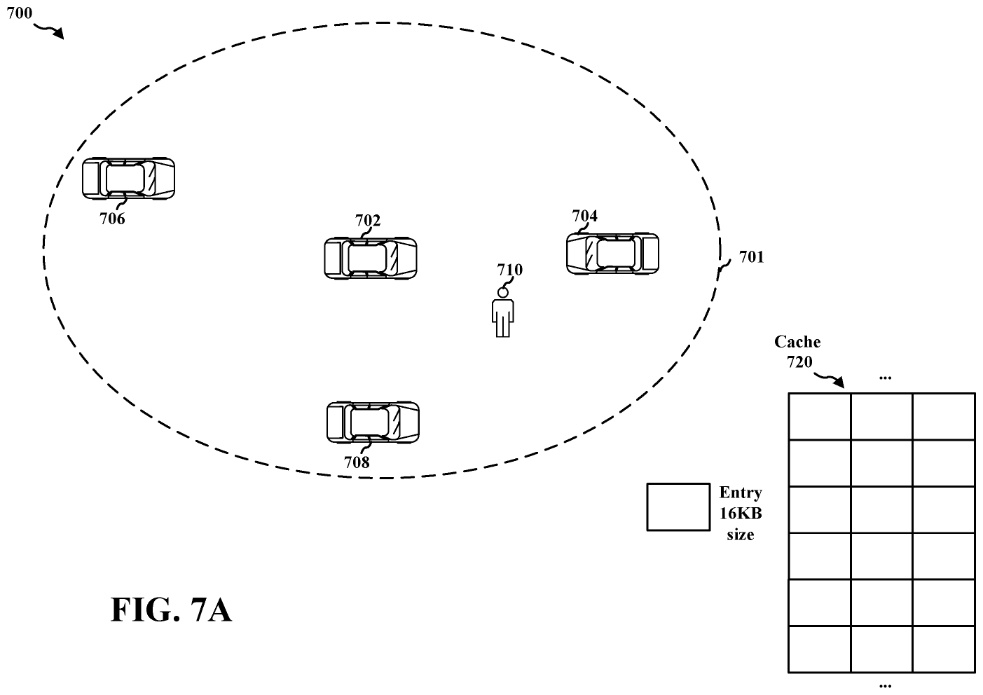

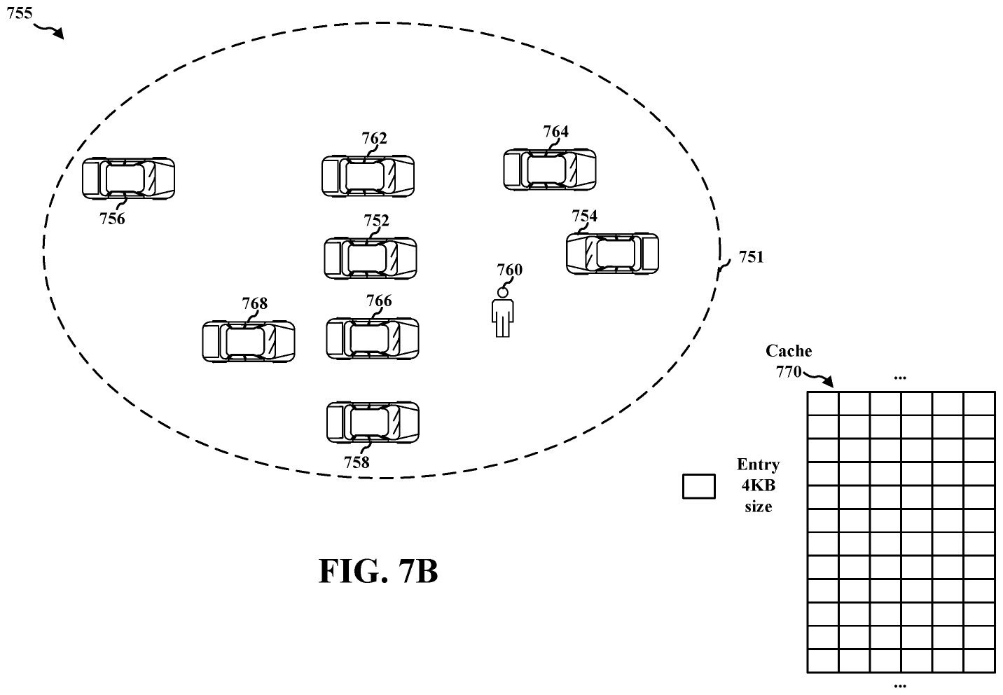

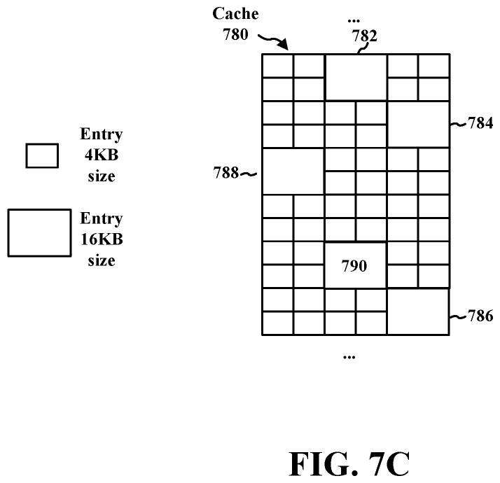

As illustrated in example 700 in FIG. 7A, the OBU 702 may be in a less congested environment (in the range 701) with OBUs 704, 706, and 708 and VRU 710. Therefore, the OBU 702 may build the cache 720 with an entry size of 16 kilobyte s (kB). The OBUs in FIG. 7A may be illustrative and may not reflect the actual number of OBUs in the range. The cache 720 in FIG. 7A may be illustrative and may not represent the actual size of the cache. For example, if the cache size for the cache 720 is 20 megabytes (MB) cache, a total of 1250 entries may be possible. As illustrated in example 755 in FIG. 7B, the OBU 752 may be in a more congested environment (in the range 751) with OBUs 754, 756, 758, 762, 764, 766, and 768 and VRU 760. Therefore, the OBU 752 may build the cache 770 with entry size 4 kB. The OBUs in FIG. 7B may be illustrative and may not reflect the actual number of OBUs in the range. The cache 770 in FIG. 7B may be illustrative and may not represent the actual size of the cache. For example, if the cache size for the cache 770 is 20 MB cache, a total of 5000 entries may be possible. In some aspects, a smaller entry size may optimize verification latency for a large number of nearby devices. In some aspects, a larger entry size may significantly optimize verification latency for a smaller number of nearby devices.

In some aspects, an OBU may determine the entry size for each entry upon generating that entry and the cache may be of mixed entry sizes. For example, as illustrated in FIG. 7C, the cache 780 may include some entries 782, 784, 786, 788, and 790 of one size such as 16 kB, and other entries of a different size such as 4 kB. The cache 780 in FIG. 7C may be illustrative and may not represent the actual size of the cache.

FIG. 8 is a flowchart 800 of a method of cache building for cryptographic verification that may be related to wireless communication. The method may be performed by a wireless device (which may be otherwise referred as a first wireless device) (e.g., the wireless device 104, the OBU 402, 404, 406, 408, 602, 702, 752; the apparatus 1002). Even though the method in some aspects is described in connection with V2X communication, the method of cache building in some other aspects may be applicable independent of wireless communication.

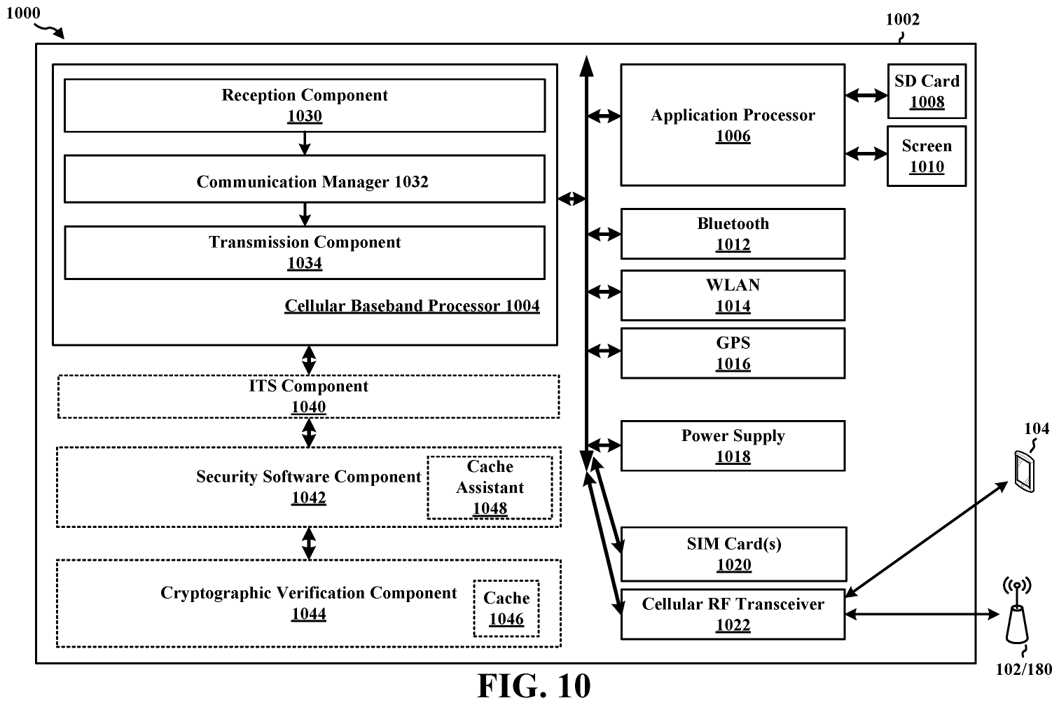

At 802, the wireless device may receive, from a second wireless device, at least one V2X message of a plurality of V2X messages, the at least one V2X message may be associated with a verification key. For example, the OBU 602, 702, or 752 may receive from a second wireless device, at least one V2X message of a plurality of V2X messages, the at least one V2X message may be associated with a verification key. In some aspects, 802 may be performed by the cellular baseband processor 1004 in FIG. 10. The wireless device may be one of an OBU, a RSU, or a VRU and the second wireless device may be one of an OBU, a RSU, or a VRU. In some aspects, the verification key may be in a security wrapper of a header in the at least one V2X message. In some aspects, the verification key corresponds to at least one application of the second wireless device. For example, the application may include one or more of: a forward collision warning, a pre-crash sensing, a cooperative collision warning, a ramp speed warning, an emergency vehicle signal preemption, a do not pass warning, a platooning message, a sensor sharing message, a cooperative driving message, a road condition warning, or other V2X applications.

At 804, the wireless device may determine whether the verification key for the at least one V2X message is a target verification key. For example, the OBU 602, 702, or 752 may determine whether the verification key for the at least one V2X message is a target verification key. In some aspects, 804 may be performed by the cache assistant 1048 in security software component 1042 in FIG. 10. As part of 804, at 814, the wireless device may determine a relevance of the verification key for the at least one V2X message. For example, the wireless device may determine that the verification key is a target verification key if the relevance is high or determine that the verification key is not a target verification key if the relevance is low. In some aspects, the wireless device may determine the relevance based on one or more of: a location of the second wireless device, a direction of movement of the second wireless device, a speed of the second wireless device, or a distance relative to the first wireless device associated with the second wireless device. In some aspects, the wireless device may further determine the relevance by performing a target classification on the second wireless device. For example, the wireless device may determine the relevance as described in connection with FIG. 6. In some aspects, the wireless device may determine the relevance of the verification key further based on a certificate expiry associated with the verification key for the at least one V2X message. For example, if the certificate associated with the verification key is expired, the wireless device may determine that the relevance is low.

In some aspects, if there is no existing entry associated with the verification key in the cache and if the verification key is the target verification key, at 808, the wireless device may determine to generate an entry in a cache for the verification key. In some aspects, 808 may be performed by the cache assistant 1048 in FIG. 10. For example, the OBU 602, 702, or 752 may determine to generate an entry in a cache for the verification key.

In some aspects, as part of 810, the wireless device may determine a size of the entry in the cache based on at least one of a: speed of the second wireless device, density of the second wireless device, a first set of one or more properties of a first area of the first wireless device, or a second set of one or more properties of a second area of the second wireless device. For example, the OBU 602, 702, or 752 may determine a size of the entry in the cache based on at least one of a: speed of the second wireless device, density of the second wireless device, a first set of one or more properties of a first area of the first wireless device, or a second set of one or more properties of a second area of the second wireless device. For example, the size of the entry may be one of a defined large size (e.g., 16 kB) or a defined small size (e.g., 4 kB). In some aspects, the first set of one or more properties or the second set of one or more properties may include a congestion level associated with the first area or the second area. For example, as previously described with FIGS. 7A and 7B, the entry size may be smaller if the congestion level is higher and the entry size may be larger if the congestion level is lower.

At 810, the wireless device may generate, upon determining to generate the entry in the cache, the entry in the cache for the verification key. For example, the OBU 602, 702, or 752 may generate, upon determining to generate the entry in the cache, the entry in the cache for the verification key. In some aspects, 810 may be performed by the cache assistant 1048 in FIG. 10. In some aspects, the entry in the cache is generated in a background session separate from a verification procedure of the verification key for the at least one V2X message. In some aspects, the background session may be associated with a first priority and the verification procedure of the verification key for the at least one V2X message may be associated with a second priority, the first priority may be than the second priority. In some aspects, the entry in the cache may be generated based on a group of wireless devices, the first and second wireless device may be included in the group of wireless devices. In some aspects, the entry in the cache may be periodically generated based on a cache building period, such as the cache building period 502 and 504 in FIG. 5. In some aspects, the cache building period may be based on one or more of: a current computing load associated with the wireless device and a predictive computing load associated with the wireless device. In some aspects, the cache building period may be further based on a V2X message arrival rate within a timeframe, e.g., as previously described in connection with FIG. 5.

FIG. 9 is a flowchart 900 of a method of cache building for cryptographic verification that may be related to wireless communication. The method may be performed by a wireless device (which may be otherwise referred as a first wireless device) (e.g., the wireless device 104, the OBU 402, 404, 406, 408, 602, 702, 752; the apparatus 1002). Even though the method in some aspects is described in connection with V2X communication, the method of cache building in some other aspects may be applicable independent of wireless communication.

At 902, the wireless device may receive, from a second wireless device, at least one V2X message of a plurality of V2X messages, the at least one V2X message may be associated with a verification key. For example, the OBU 602, 702, or 752 may receive from a second wireless device, at least one V2X message of a plurality of V2X messages, the at least one V2X message may be associated with a verification key. In some aspects, 902 may be performed by the cellular baseband processor 1004 in FIG. 10. The wireless device may be one of an OBU, a RSU, or a VRU and the second wireless device may be one of an OBU, a RSU, or a VRU. In some aspects, the verification key may be in a security wrapper of a header in the at least one V2X message. In some aspects, the verification key corresponds to at least one application of the second wireless device. For example, the application may include one or more of: a forward collision warning, a pre-crash sensing, a cooperative collision warning, a ramp speed warning, an emergency vehicle signal preemption, a do not pass warning, a platooning message, a sensor sharing message, a cooperative driving message, a road condition warning, or other V2X applications.

In some aspects, at 912, the wireless device may route the at least one message from a cellular C-V2X modem, such as the cellular baseband processor 1004, to an ITS stack, such as the ITS component 1040, or a security software module, such as the security software component 1042 and the cryptographic verification component 1044. For example, the OBU 602, 702, or 752 may route the at least one message from a cellular C-V2X modem to an ITS stack. In some aspects, 912 may be performed by the cellular baseband processor 1004 in FIG. 10.

At 904, the wireless device may determine whether the verification key for the at least one V2X message is a target verification key. For example, the OBU 602, 702, or 752 may determine whether the verification key for the at least one V2X message is a target verification key. In some aspects, 904 may be performed by the cache assistant 1048 in security software component 1042 in FIG. 10. As part of 904, at 914, the wireless device may determine a relevance of the verification key for the at least one V2X message. For example, the wireless device may determine that the verification key is a target verification key if the relevance is high or determine that the verification key is not a target verification key if the relevance is low. In some aspects, the wireless device may determine the relevance based on one or more of: a location of the second wireless device, a direction of movement of the second wireless device, a speed of the second wireless device, or a distance relative to the first wireless device associated with the second wireless device. In some aspects, the wireless device may further determine the relevance by performing a target classification on the second wireless device. For example, the wireless device may determine the relevance as described in connection with FIG. 6. In some aspects, the wireless device may determine the relevance of the verification key further based on a certificate expiry associated with the verification key for the at least one V2X message. For example, if the certificate associated with the verification key is expired, the wireless device may determine that the relevance is low.

In some aspects, the wireless device may determine whether the verification key for the at least one V2X message is the target verification key is further based on one or more of: a frequency of use of the verification key, a set of application plane metadata associated with the at least one V2X message, a consideration range associated with the second wireless device, a time to collision associated with the second wireless device, or a local dynamic map associated with a group of wireless devices including the first wireless device and the second wireless device within an area. For example, the consideration range may correspond with the range 660, 701, 751, or the like. In some aspects, the consideration range is based on one or more of a location of the second wireless device, a speed of the second wireless device, or a distance relative to the first wireless device associated with the second wireless device. In some aspects, the set of application plane metadata may include one or more of: BSM metadata, MAP metadata, SPaT metadata, TIM metadata, RSM metadata, SRM metadata, CAM metadata, SSM metadata, Global Navigation Satellite System (GNSS) metadata or Radio Technical Commission for Maritime Services (RTCM) metadata, SDSM metadata, MSCM metadata, CACC metadata, or PVD metadata. In some aspects, the local dynamic map may include a duration of an exposure history associated with the group of wireless devices within the area. The duration of the exposure history may represent each wireless device's frequency and duration of being present near the wireless device. For example, if the wireless device is frequently near an RSU A, the duration of the exposure history may represent that RSU A is frequently near the wireless device and a period of time associated with the presence.

At 906, the wireless device may determine whether there is an existing entry associated with the verification key in the cache. For example, the OBU 602, 702, or 752 may determine whether there is an existing entry associated with the verification key in the cache. In some aspects, 906 may be performed by the cache assistant 1048 in FIG. 10. In some aspects, the entry in the cache may correspond to information for the verification key. For example, the information for the verification key may include a set of cryptographic cipher specific pre-computed mathematical operations for the verification key. In some aspects, the cache may correspond with the cache 720, 770, 780, or 1046. In some aspects, the cache may be a lookup table (LUT).

In some aspects, if there is an existing entry associated with the verification key in the cache, at 916, the wireless device may perform verification of the verification key based on the existing entry (such as by performing verification in a procedure). For example, the OBU 602, 702, or 752 may perform verification of the verification key based on the existing entry. In some aspects, 916 may be performed by the cryptographic verification component 1044 in FIG. 10.

In some aspects, if there is no existing entry associated with the verification key in the cache and if the verification key is the target verification key, at 908, the wireless device may determine to generate an entry in a cache for the verification key. In some aspects, 908 may be performed by the cache assistant 1048 in FIG. 10. For example, the OBU 602, 702, or 752 may determine to generate an entry in a cache for the verification key. In some aspects, as part of 908, at 920, the wireless device may determine a cache size limit associated with the cache. For example, the OBU 602, 702, or 752 may determine a cache size limit associated with the cache. The cache size limit may be the total size limit for the entire cache. In some aspects, if the wireless device determines that the cache size limit supports continuous generation of one or more caches associated with one or more target verification keys with a usage frequency below a threshold at 924, the wireless device may determine to generate the entry in the cache for the verification key. In some aspects, if the wireless device determines that the cache size limit do not support continuous generation of one or more caches associated with one or more target verification keys with a usage frequency below a threshold, the wireless device may compare a first usage frequency associated with one or more entries with a second usage frequency associated with the target verification key at 922. If the first usage frequency is lower than the second usage frequency by a defined threshold, such as Y Hz, the wireless device may generate the entry in the cache for the verification key by replacing the one or more entries with the entry at 926 (as part of 910).

In some aspects, as part of 910, the wireless device may determine a size of the entry in the cache based on at least one of a: speed of the second wireless device, density of the second wireless device, a first set of one or more properties of a first area of the first wireless device, or a second set of one or more properties of a second area of the second wireless device. For example, the OBU 602, 702, or 752 may determine a size of the entry in the cache based on at least one of a: speed of the second wireless device, density of the second wireless device, a first set of one or more properties of a first area of the first wireless device, or a second set of one or more properties of a second area of the second wireless device. For example, the size of the entry may be one of a defined large size (e.g., 16 kB) or a defined small size (e.g., 4 kB). In some aspects, the first set of one or more properties or the second set of one or more properties may include a congestion level associated with the first area or the second area. For example, as previously described with FIGS. 7A and 7B, the entry size may be smaller if the congestion level is higher and the entry size may be larger if the congestion level is lower.

At 910, the wireless device may generate, upon determining to generate the entry in the cache, the entry in the cache for the verification key. For example, the OBU 602, 702, or 752 may generate, upon determining to generate the entry in the cache, the entry in the cache for the verification key. In some aspects, 910 may be performed by the cache assistant 1048 in FIG. 10. In some aspects, the entry in the cache is generated in a background session separate from a verification procedure of the verification key for the at least one V2X message. In some aspects, the background session may be associated with a first priority and the verification procedure of the verification key for the at least one V2X message may be associated with a second priority, the first priority may be than the second priority. In some aspects, the entry in the cache may be generated based on a group of wireless devices, the first and second wireless device may be included in the group of wireless devices. In some aspects, the entry in the cache may be periodically generated based on a cache building period, such as the cache building period 502 and 504 in FIG. 5. In some aspects, the cache building period may be based on one or more of: a current computing load associated with the wireless device and a predictive computing load associated with the wireless device. In some aspects, the cache building period may be further based on a V2X message arrival rate within a timeframe, e.g., as previously described in connection with FIG. 5.

FIG. 10 is a diagram 1000 illustrating an example of a hardware implementation for an apparatus 1002. The apparatus 1002 is a wireless device and includes a cellular baseband processor 1004 (also referred to as a modem) coupled to a cellular RF transceiver 1022 and one or more subscriber identity modules (SIM) cards 1020, an application processor 1006 coupled to a secure digital (SD) card 1008 and a screen 1010, a Bluetooth module 1012, a wireless local area network (WLAN) module 1014, a Global Positioning System (GPS) module 1016, and a power supply 1018. The cellular baseband processor 1004 communicates through the cellular RF transceiver 1022 with the wireless device 104 and/or BS 102/180. The cellular baseband processor 1004 may include a computer-readable medium/memory. The computer-readable medium/memory may be non-transitory. The cellular baseband processor 1004 is responsible for general processing, including the execution of software stored on the computer-readable medium/memory. The software, when executed by the cellular baseband processor 1004, causes the cellular baseband processor 1004 to perform the various functions described supra. The computer-readable medium/memory may also be used for storing data that is manipulated by the cellular baseband processor 1004 when executing software. The cellular baseband processor 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the cellular baseband processor 1004. The cellular baseband processor 1004 may be a component of the wireless device 350 and may include the memory 360 and/or at least one of the TX processor 368, the RX processor 356, and the controller/processor 359. In one configuration, the apparatus 1002 may be a modem chip and include just the baseband processor 1004, and in another configuration, the apparatus 1002 may be the entire wireless device (e.g., see 350 of FIG. 3) and include the aforediscussed additional modules of the apparatus 1002. The communication manager 1032 may receive, from a second wireless device, at least one V2X message of a plurality of V2X messages, the at least one V2X message may be associated with a verification key, as described in connection with 802 in FIG. 8, and 902 in FIG. 9.

The apparatus 1002 may further include an ITS component 1040, a security software component 1042 which may include a cache assistant 1048, and a cryptographic verification component 1044 which may include a cache 1046 as previously described with FIG. 8. The cache 1046 may correspond with the cache 720, 770, and 780 described in connection with FIGS. 7A-7C. In some aspects, the cryptographic verification component 1044 may be configured to perform verification of a V2X message, based on or independent of an entry in the cache. In some aspects, the security software component 1042 may be configured to determine, if the verification key is the target verification key, to generate an entry in a cache for the verification key, e.g., as described in connection with 808 in FIG. 8, and 908 in FIG. 9. In some aspects, the security software component 1042 may be configured to generate, upon determining to generate the entry in the cache, the entry in the cache for the verification key, e.g., as described in connection with 810 in FIG. 8, and 910 in FIG. 9.

The apparatus may include additional components that perform each of the blocks of the algorithm in the aforementioned flowcharts of FIGS. 8-9. As such, each block in the aforementioned flowcharts of FIGS. 8-9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In some aspects, the apparatus 1002 may include means for receiving, from a second wireless device, at least one V2X message of a plurality of V2X messages, the at least one V2X message being associated with a verification key. In some aspects, the apparatus 1002 may further include means for determining whether the verification key for the at least one V2X message is a target verification key. In some aspects, the apparatus 1002 may further include means for determining, if the verification key is the target verification key, to generate an entry in a cache for the verification key. In some aspects, the apparatus 1002 may further include means for determining a relevance of the verification key for the at least one V2X message based on one or more of: a location of the second wireless device, a direction of movement of the second wireless device, a speed of the second wireless device, or a distance relative to the first wireless device associated with the second wireless device. In some aspects, the apparatus 1002 may further include means for performing a target classification on the second wireless device. In some aspects, the apparatus 1002 may further include means for determining a size of the entry in the cache based on at least one of a: speed of the second wireless device, density of the second wireless device, a first set of one or more properties of a first area of the first wireless device, or a second set of one or more properties of a second area of the second wireless device. In some aspects, the apparatus 1002 may further include means for determining a cache size limit associated with the cache. In some aspects, the apparatus 1002 may further include means for determining that the cache size limit supports continuous generation of one or more caches associated with one or more target verification keys with a usage frequency below a threshold. In some aspects, the apparatus 1002 may further include means for comparing a first usage frequency associated with one or more entries with a second usage frequency associated with the target verification key, the second usage frequency being higher than the first usage frequency. In some aspects, the apparatus 1002 may further include means for generating the entry in the cache for the verification key includes replacing the one or more entries with the entry. In some aspects, the apparatus 1002 may further include means for receiving at least one message associated with a verification key. In some aspects, the apparatus 1002 may further include means for determining whether the verification key is a target verification key. In some aspects, the apparatus 1002 may further include means for determining, if the verification key is the target verification key, to generate an entry in a cache for the verification key by determining a relevance of the verification key. In some aspects, the apparatus 1002 may further include means for determining a size of the entry in the cache. In some aspects, the apparatus 1002 may further include means for generating, upon determining to generate the entry in the cache and the size, the entry in the cache for the verification key and the size, where the entry in the cache is generated in a background session separate from a verification procedure of the verification key.

The aforementioned means may be one or more of the aforementioned components of the apparatus 1002 configured to perform the functions recited by the aforementioned means. As described supra, the apparatus 1002 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used in this disclosure outside of the claims, the phrase “based on” is inclusive of all interpretations and shall not be limited to any single interpretation unless specifically recited or indicated as such. For example, the phrase “based on A” (where “A” may be information, a condition, a factor, or the like) may be interpreted as: “based at least on A,” “based in part on A,” “based at least in part on A,” “based only on A,” or “based solely on A.” Accordingly, as disclosed herein, “based on A” may, in one aspect, refer to “based at least on A.” In another aspect, “based on A” may refer to “based in part on A.” In another aspect, “based on A” may refer to “based at least in part on A.” In another aspect, “based on A” may refer to “based only on A.” In another aspect, “based on A” may refer to “based solely on A.” In another aspect, “based on A” may refer to any combination of interpretations in the alternative. As used in the claims, the phrase “based on A” shall be interpreted as “based at least on A” unless specifically recited differently.

The following aspects are illustrative only and may be combined with other aspects or teachings described herein, without limitation.

The following aspects are illustrative only and may be combined with other aspects or teachings described herein, without limitation.

Aspect 1 is a method of cache building for cryptographic verification related to wireless communication at a first wireless device, including: receiving, from a second wireless device, at least one V2X message of a plurality of V2X messages, the at least one V2X message being associated with a verification key; determining whether the verification key for the at least one V2X message is a target verification key; determining, if the verification key is the target verification key, to generate an entry in a cache for the verification key; and generating, upon determining to generate the entry in the cache, the entry in the cache for the verification key.

Aspect 2 is the method of aspect 1, where the verification key is in a security wrapper of a header in the at least one V2X message.

Aspect 3 is the method of any of aspects 1-2, where the verification key corresponds to at least one application of the second wireless device.

Aspect 4 is the method of any of aspects 1-3, where the application includes one or more of: a forward collision warning, a pre-crash sensing, a cooperative collision warning, a ramp speed warning, an emergency vehicle signal preemption, a do not pass warning, a platooning message, a sensor sharing message, a cooperative driving message, or a road condition warning.

Aspect 5 is the method of any of aspects 1-4, where determining whether the verification key for the at least one V2X message is the target verification key include s determining a relevance of the verification key for the at least one V2X message based on one or more of: a location of the second wireless device, a direction of movement of the second wireless device, a speed of the second wireless device, or a distance relative to the first wireless device associated with the second wireless device.

Aspect 6 is the method of any of aspects 1-5, where determining the relevance of the verification key further includes performing a target classification on the second wireless device.

Aspect 7 is the method of any of aspects 1-6, where determining the relevance of the verification key is further based on a certificate expiry associated with the verification key for the at least one V2X message.

Aspect 8 is the method of any of aspects 1-7, where determining whether the verification key for the at least one V2X message is the target verification key is further based on one or more of: a frequency of use of the verification key, a set of application plane metadata associated with the at least one V2X message, a consideration range associated with the second wireless device, a time to collision associated with the second wireless device, or a local dynamic map associated with a group of wireless devices including the first wireless device and the second wireless device within an area.

Aspect 9 is the method of any of aspects 1-8, where the set of application plane metadata includes one or more of: BSM metadata, MAP metadata, SPaT metadata, CAM metadata, TIM metadata, RSM metadata, SRM metadata, SSM metadata, GNSS or RTCM metadata, a SDSM metadata, a MSCM metadata, a CACC metadata, or PVD metadata.

Aspect 10 is the method of any of aspects 1-9, where the consideration range is based on one or more of a location of the second wireless device, a speed of the second wireless device, or a distance relative to the first wireless device associated with the second wireless device.

Aspect 11 is the method of any of aspects 1-10, where the local dynamic map further includes a duration of an exposure history associated with the group of wireless devices within the area.

Aspect 12 is the method of any of aspects 1-11, where the entry in the cache corresponds to information for the verification key.

Aspect 13 is the method of any of aspects 1-12, where the information for the verification key includes a set of cryptographic cipher specific pre-computed mathematical operations for the verification key.

Aspect 14 is the method of any of aspects 1-13, where the cache is a LUT.

Aspect 15 is the method of any of aspects 1-14, further including: determining a size of the entry in the cache based on at least one of a: speed of the second wireless device, density of the second wireless device, a first set of one or more properties of a first area of the first wireless device, or a second set of one or more properties of a second area of the second wireless device.

Aspect 16 is the method of any of aspects 1-15, where the first set of one or more properties or the second set of one or more properties may include a congestion level associated with the first area or the second area.

Aspect 17 is the method of any of aspects 1-16, where the entry in the cache is generated based on a group of wireless devices, where the first and second wireless device are included in the group of wireless devices.

Aspect 18 is the method of any of aspects 1-17, where the entry in the cache is periodically generated based on a cache building period.

Aspect 19 is the method of any of aspects 1-18, where the cache building period is based on one or more of: a current computing load associated with the first wireless device and a predictive computing load associated with the first wireless device.

Aspect 20 is the method of any of aspects 1-19, where the cache building period is further based on a V2X message arrival rate within a timeframe.

Aspect 21 is the method of any of aspects 1-20, where the entry in the cache is generated in a background session separate from a verification procedure of the verification key for the at least one V2X message.

Aspect 22 is the method of any of aspects 1-21, where the background session is associated with a first priority and the verification procedure of the verification key for the at least one V2X message is associated with a second priority, the first priority being lower than the second priority.

Aspect 23 is the method of any of aspects 1-22, further including: determining a cache size limit associated with the cache.

Aspect 24 is the method of any of aspects 1-23, where determining to generate the entry in the cache for the verification key includes determining that the cache size limit supports continuous generation of one or more caches associated with one or more target verification keys with a usage frequency below a threshold.

Aspect 25 is the method of any of aspects 1-24, where: determining to generate the entry in the cache for the verification key includes comparing a first usage frequency associated with one or more entries with a second usage frequency associated with the target verification key, the second usage frequency being higher than the first usage frequency; and generating the entry in the cache for the verification key includes replacing the one or more entries with the entry.

Aspect 26 is the method of any of aspects 1-25, where the first wireless device is one of an OBU deployed at a car, a RSU, or a device with a VRU, and the second wireless device is one of an OBU, a RSU, or a VRU.

Aspect 27 is the method of any of aspects 1-26, further including: routing the at least one V2X message from a C-V2X modem to an ITS stack or a security software module.

Aspect 28 is the method of any of aspects 1-27, where determining to generate the entry in the cache for the verification key includes: determining whether there is an existing entry associated with the verification key in the cache; upon determining that there is the existing entry associated with the verification key in the cache, performing verification of the verification key based on the existing entry; and upon determining that there is not the existing entry associated with the verification key in the cache, generating the entry in the cache.

Aspect 29 is a method of cache building for cryptographic verification at a computing device, including: receiving at least one message associated with a verification key; determining whether the verification key is a target verification key; determining, if the verification key is the target verification key, to generate an entry in a cache for the verification key by determining a relevance of the verification key; determining a size of the entry in the cache; and generating, upon determining to generate the entry in the cache and the size, the entry in the cache for the verification key and the size, where the entry in the cache is generated in a background session separate from a verification procedure of the verification key.

Aspect 30 is the method of aspect 29, where: determining to generate the entry in the cache for the verification key includes comparing a first usage frequency associated with one or more entries with a second usage frequency associated with the target verification key, the second usage frequency being higher than the first usage frequency; and generating the entry in the cache for the verification key includes replacing the one or more entries with the entry.

Aspect 31 is the method of any of aspects 29-30, where the entry in the cache is periodically generated based on a cache building period.

Aspect 32 is the method of any of aspects 29-31, where the cache building period is based on one or more of: a current computing load associated with the computing device and a predictive computing load associated with the computing device.

Aspect 33 is the method of any of aspects 29-32, where determining to generate the entry in the cache for the verification key includes: determining whether there is an existing entry associated with the verification key in the cache; upon determining that there is the existing entry associated with the verification key in the cache, performing verification of the verification key based on the existing entry; and upon determining that there is not the existing entry associated with the verification key in the cache, generating the entry in the cache.

Aspect 34 is an apparatus for cache building for cryptographic verification related to wireless communication, including: a memory; and at least one processor coupled to the memory and configured to: receive, from a second wireless device, at least one V2X message of a plurality of V2X messages, the at least one V2X message being associated with a verification key; determine whether the verification key for the at least one V2X message is a target verification key; determine, if the verification key is the target verification key, to generate an entry in a cache for the verification key; and generate, upon determining to generate the entry in the cache, the entry in the cache for the verification key.

Aspect 35 is the apparatus of aspect 34, where the at least one processor is configured to perform the method of any of aspects 2-28, and where the at least one processor is coupled to at least one of a transceiver or an antenna.

Aspect 36 is an apparatus for cache building for cryptographic verification related to wireless communication, including: means for receiving, from a second wireless device, at least one V2X message of a plurality of V2X messages, the at least one V2X message being associated with a verification key; means for determining whether the verification key for the at least one V2X message is a target verification key; means for determining, if the verification key is the target verification key, to generate an entry in a cache for the verification key; and means for generating, upon determining to generate the entry in the cache, the entry in the cache for the verification key.

Aspect 37 is the apparatus of aspect 36, further including means to perform the method of any of aspects 2-28.

Aspect 38 is a computer-readable medium storing computer executable code, the code when executed by a processor causes the processor to: receive, from a second wireless device, at least one V2X message of a plurality of V2X messages, the at least one V2X message being associated with a verification key; determine whether the verification key for the at least one V2X message is a target verification key; determine, if the verification key is the target verification key, to generate an entry in a cache for the verification key; and generate, upon determining to generate the entry in the cache, the entry in the cache for the verification key.

Aspect 39 is the computer-readable medium of aspect 38, where the code when executed by the processor causes the processor to perform the method of any of aspects 2-28.

Aspect 40 is an apparatus for cache building for cryptographic verification at a computing device, including: a memory; and at least one processor coupled to the memory and configured to perform the method of any of aspects 29-33, and the at least one processor may be coupled to at least one of a transceiver or an antenna.

Aspect 41 is an apparatus for cache building for cryptographic verification at a computing device, including means for performing the method of any of aspects 29-33.

Aspect 42 is a computer-readable medium storing computer executable code, the code when executed by a processor causes the processor to perform the method of any of aspects 29-33.

What is claimed is:

1. An apparatus for cache building for cryptographic verification related to communication at a first wireless device, comprising:
a memory; and
at least one processor coupled to the memory and, based at least in part on information stored in the memory, the at least one processor is configured to:
receive, from a second wireless device, at least one vehicle-to-everything (V2X) message of a plurality of V2X messages, the at least one V2X message being associated with a verification key;
determine whether the verification key for the at least one V2X message is a target verification key;
determine, if the verification key is the target verification key, to generate an entry in a cache for the verification key; and
generate, upon determining to generate the entry in the cache, the entry in the cache for the verification key.

2. The apparatus of claim 1, wherein the verification key is in a security wrapper of a header in the at least one V2X message, or wherein the verification key corresponds to at least one application of the second wireless device.

3. The apparatus of claim 2, wherein the at least one application includes one or more of: a forward collision warning, a pre-crash sensing, a cooperative collision warning, a ramp speed warning, an emergency vehicle signal preemption, a do not pass warning, a platooning message, a sensor sharing message, a cooperative driving message, or a road condition warning.

4. The apparatus of claim 1, wherein the at least one processor is configured to determine whether the verification key for the at least one V2X message is the target verification key by: determining a relevance of the verification key for the at least one V2X message based on one or more of: a location of the second wireless device, a direction of movement of the second wireless device, a speed of the second wireless device, or a distance relative to the first wireless device associated with the second wireless device.

5. The apparatus of claim 4, wherein the at least one processor is configured to determine the relevance of the verification key by performing a target classification on the second wireless device.

6. The apparatus of claim 5, wherein the at least one processor is configured to determine the relevance of the verification key based on a certificate expiry associated with the verification key for the at least one V2X message.

7. The apparatus of claim 1, wherein the at least one processor is configured to determine whether the verification key for the at least one V2X message is the target verification key based on one or more of: a frequency of use of the verification key, a set of application plane metadata associated with the at least one V2X message, a consideration range associated with the second wireless device, a time to collision associated with the second wireless device, or a local dynamic map associated with a group of wireless devices including the first wireless device and the second wireless device within an area.

8. The apparatus of claim 7, wherein the set of application plane metadata includes one or more of: basic safety message (BSM) metadata, intersection mapping (MAP) metadata, signal phase and timing (SPaT) metadata, cooperative aware message (CAM) metadata, traveler information message (TIM) metadata, road safety management (RSM) metadata, signal request message (SRM) metadata, signal status message (SSM) metadata, Global Navigation Satellite System (GNSS) or Radio Technical Commission for Maritime Services (RTCM) metadata, a sensor data sharing message (SDSM) metadata, a maneuver sharing and coordinating message (MSCM) metadata, a cooperative adaptive cruise control (CACC) metadata, or probe vehicle data (PVD) metadata.

9. The apparatus of claim 7, wherein the consideration range is based on one or more of a location of the second wireless device, a speed of the second wireless device, or a distance relative to the first wireless device associated with the second wireless device.

10. The apparatus of claim 7, wherein the local dynamic map further includes a duration of an exposure history associated with the group of wireless devices within the area.

11. The apparatus of claim 1, wherein the entry in the cache corresponds to first information for the verification key, and wherein the first information for the verification key comprises a set of cryptographic cipher specific pre-computed mathematical operations for the verification key.

12. The apparatus of claim 1, wherein the cache is a lookup table (LUT).

13. The apparatus of claim 1, wherein the at least one processor is further configured to: determine a size of the entry in the cache based on at least one of a: speed of the second wireless device, density of the second wireless device, a first set of one or more properties of a first area of the first wireless device, or a second set of one or more properties of a second area of the second wireless device, wherein the first set of one or more properties or the second set of one or more properties comprises a congestion level associated with the first area or the second area.

14. The apparatus of claim 1, wherein the entry in the cache is generated based on a group of wireless devices, wherein the first wireless device and the second wireless device are included in the group of wireless devices.

15. The apparatus of claim 1, wherein the entry in the cache is periodically generated based on a cache building period, wherein the cache building period is based on one or more of: a current computing load associated with the first wireless device and a predictive computing load associated with the first wireless device or wherein the cache building period is further based on a V2X message arrival rate within a timeframe.

16. The apparatus of claim 1, wherein the entry in the cache is generated in a background session separate from a verification procedure of the verification key for the at least one V2X message.

17. The apparatus of claim 16, wherein the background session is associated with a first priority and the verification procedure of the verification key for the at least one V2X message is associated with a second priority, the first priority being lower than the second priority.

18. The apparatus of claim 1, wherein the at least one processor is further configured to: determine a cache size limit associated with the cache.

19. The apparatus of claim 18, wherein the at least one processor is configured to determine to generate the entry in the cache for the verification key by determining that the cache size limit supports continuous generation of one or more caches associated with one or more target verification keys with a usage frequency below a threshold.

20. The apparatus of claim 19, wherein:
determining to generate the entry in the cache for the verification key comprises comparing a first usage frequency associated with one or more entries with a second usage frequency associated with the target verification key, the second usage frequency being higher than the first usage frequency; and
generating the entry in the cache for the verification key comprises replacing the one or more entries with the entry.

21. The apparatus of claim 1, wherein the first wireless device is one of an on board unit (OBU) deployed at a car, a road side unit (RSU), or a device with a vulnerable road user (VRU), and the second wireless device is one of the OBU, the RSU, or the VRU.

22. The apparatus of claim 1, wherein the at least one processor is further configured to:
route the at least one V2X message from a cellular vehicle-to-everything (C-V2X) modem to an intelligent transport system (ITS) stack or a security software module.

23. The apparatus of claim 1, wherein the at least one processor is configured to determine to generate the entry in the cache for the verification key by:
determining whether there is an existing entry associated with the verification key in the cache; and
upon determining that there is not the existing entry associated with the verification key in the cache, generating the entry in the cache.

24. The apparatus of claim 1, further comprising a transceiver or an antenna coupled to the at least one processor.

25. An apparatus for cache building for cryptographic verification at a computing device, comprising:
a memory; and
at least one processor coupled to the memory and, based at least in part on information stored in the memory, the at least one processor is configured to:
receive at least one message associated with a verification key;
determine whether the verification key is a target verification key;
determine, if the verification key is the target verification key, to generate an entry in a cache for the verification key by determining a relevance of the verification key;
determine a size of the entry in the cache; and
generate, upon determining to generate the entry in the cache and the size, the entry in the cache for the verification key and the size, wherein the entry in the cache is generated in a background session separate from a verification procedure of the verification key.

26. The apparatus of claim 25, wherein the at least one processor is configured to determine to generate the entry in the cache for the verification key by:
comparing a first usage frequency associated with one or more entries with a second usage frequency associated with the target verification key, the second usage frequency being higher than the first usage frequency; and
generating the entry in the cache for the verification key comprises replacing the one or more entries with the entry.

27. The apparatus of claim 25, wherein the entry in the cache is periodically generated based on a cache building period, and wherein the cache building period is based on one or more of: a current computing load associated with the computing device and a predictive computing load associated with the computing device.

28. The apparatus of claim 25, determine to generate the entry in the cache for the verification key by:
determining whether there is an existing entry associated with the verification key in the cache; and
upon determining that there is not the existing entry associated with the verification key in the cache, generating the entry in the cache.

29. A method of cache building for cryptographic verification related to communication at a first wireless device, comprising:
receiving, from a second wireless device, at least one vehicle-to-everything (V2X) message of a plurality of V2X messages, the at least one V2X message being associated with a verification key;
determining whether the verification key for the at least one V2X message is a target verification key;
determining, if the verification key is the target verification key, to generate an entry in a cache for the verification key; and
generating, upon determining to generate the entry in the cache, the entry in the cache for the verification key.

30. A method of cache building for cryptographic verification at a computing device, comprising:
receiving at least one message associated with a verification key;
determining whether the verification key is a target verification key;
determining, if the verification key is the target verification key, to generate an entry in a cache for the verification key by determining a relevance of the verification key;
determining a size of the entry in the cache; and
generating, upon determining to generate the entry in the cache and the size, the entry in the cache for the verification key and the size, wherein the entry in the cache is generated in a background session separate from a verification procedure of the verification key.
